(19) United States
(12) Patent Application Publication
(10) Pub. No.: US 2019/0159598 A1
(43) Pub. Date: May 30, 2019

(54) SEAT WITH A FLIPPING FOOTREST ASSEMBLY

(71) Applicant: LIQ MENG CORP., Taipei City (TW)

(72) Inventors: YEN-CHUAN LEE, TAIPEI CITY (TW); QING-KUN YIN, TAIPEI CITY (TW)

(21) Appl. No.: 16/128,838

(22) Filed: Sep. 12, 2018

(30) Foreign Application Priority Data
Nov. 29, 2017 (CN) 201721621412.2

(51) Int. Cl. A47C 7/50; B60N 2/90

(52) U.S. Cl. CPC A47C 7/5066; B60N 2/933; B60N 2/995

(57) ABSTRACT

A seat with a flipping footrest assembly has a cushion, a seat back, and a footrest assembly. A front surface of the cushion is a convex surface. The seat back is mounted on a rear surface of the cushion. The footrest assembly is pivotally mounted on the front surface of the cushion and comprises a first footrest and a second footrest, and the first footrest is pivotally mounted on the front surface of the cushion. A concave rear surface of the first footrest is capable of moving along the front surface of the cushion, which is covex. The second footrest is pivotally mounted on the first footrest. The corresponding shapes between the first footrest and the cushion allows user to comfortably stretch legs when the first footrest is flipped up, because there will be no excessive holes and gaps between the first footrest and the cushion.

### CROSS-REFERENCE TO RELATED APPLICATIONS

This application is based upon and claims priority under 35 U.S.C. 119 from China Patent Application No. 201721621412.2 filed on Nov. 29, 2017, which is hereby specifically incorporated herein by this reference thereto.

### BACKGROUND OF THE INVENTION

### 1. Field of the Invention

The present invention relates to a seat, especially to a seat with a flipping footrest assembly.

### 2. Description of the Prior Arts

In the modern society, due to the change in lifestyle and work, people are spending more and more time sitting, no matter when it is at work, commuting in cars, or even when having a break. However, staying in such a sedentary posture over a long period is detrimental to human health. For example, it could weaken the muscles and lower the flexibility in the blood vessels. To overcome the health problems brought by this modern disease, seats and chairs with different kinds of functions are invented.

Among them, the design for seats used in a car often includes a cushion, a seat back, and a headrest. The seat back is mounted on top of the cushion and extends upwardly. The headrest is mounted on top of the seat back. However, this kind of seat structure does not include any particular design for the legs and feet to rest thereon. Specifically, in a car, a driver and passengers are forced to have their legs bent. Therefore, if the traveling time is long, there is no proper and effective way in a car for the driver and the passengers to stretch and rest their legs. Therefore, the conventional car seat is defective. To overcome the shortcomings, the present invention provides a seat with a flipping footrest to mitigate or obviate the aforementioned problems.

### SUMMARY OF THE INVENTION

The main objective of the present invention is to provide a seat with a flipping footrest assembly. When necessary, the user may expand the footrest assembly and turn it into a place where the feet and legs can be rest.

The seat with a flipping footrest assembly has a cushion, a seat back, and a footrest assembly. The cushion has a front surface which is a convex surface. The seat back is mounted on a rear surface of the cushion and extends upwardly. The footrest assembly is pivotally mounted on the front surface of the cushion, is capable of pivoting up and down relative to the cushion, and comprises a first footrest and a second footrest. The first footrest is pivotally mounted in the front surface of the cushion and is capable of pivoting up and down relative to the cushion. A rear surface of the first footrest is adjacent to the front surface of the cushion and is a concave surface. The rear surface of the first footrest corresponds in shape to the front surface of the cushion. When the first footrest pivots up and down relative to the cushion, the rear surface of the first footrest moves along the front surface of the cushion. The second footrest is pivotally mounted on the first footrest and is capable of pivoting up and down relative to the first footrest.

Moreover, the footrest assembly comprises a folded condition, a partially expanded condition, and an expanded condition. In the folded condition, the first footrest pivots relative to the cushion and pivots to a position below the cushion, and the second footrest pivots relative to the first footrest and pivots to a rear end of the first footrest. In the partially expanded condition, the first footrest pivots relative to the cushion and pivots to a front end of the cushion, the rear surface of the first footrest is disposed close to the front surface of the cushion, so from a side view, an extended surface of a top surface of the first footrest and a top surface of the cushion jointly form a continuous and smooth line, and the second footrest is disposed to a position below the first footrest. In the expanded condition, the second footrest pivots relative to the first footrest and pivots to a front end of the first footrest, so the top surface of the first footrest and a top surface of the second footrest jointly form a continuous surface, and the second footrest, the first footrest and the cushion are disposed sequentially from front to rear.

Given the foregoing structure of the seat with a flipping footrest assembly and in the premise of not leaving the car, the user may pivot the footrest assembly relative to the cushion and expand it, so the user may lay their legs on the footrest assembly. Therefore the user may adequately stretch their legs inside the car, especially during a long distant drive, so the bent legs may have some relief from staying in such posture for a long time. On the other hand, the conventional car seat is not equipped with a structure that is specially designed to support and hold the legs, therefore the presented invention can offer a more comfortable seating experience. Meanwhile, because the rear surface of the first footrest corresponds in shape to the front surface of the cushion, which is a convex surface, when the user flips up the first footrest, the top surface of the cushion and the top surface of the first footrest can jointly form a smooth and almost continuous surface, so when the users put their legs thereon, they can barely feel any discontinuity or interspaces between the cushion and the first footrest, which may also enhance the comfort level of the present invention.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a seat with a flipping footrest assembly in accordance with the present invention;

FIG. 2 is a partially exploded perspective view of the seat in FIG. 1;

FIG. 3 is a cross sectional view of the seat in FIG. 1 in the expanded condition;

FIG. 4 is a cross sectional view of the seat in FIG. 1 in the partially expanded condition;

FIG. 5 is a cross sectional view of the seat in FIG. 1 in the folded condition;

FIG. 6 is a cross sectional view of the footrest assembly in accordance with the present invention;

FIG. 7 is another partially exploded perspective view of the seat in FIG. 1.

### DETAILED DESCRIPTION OF THE PREFERRED EMBODIMENTS

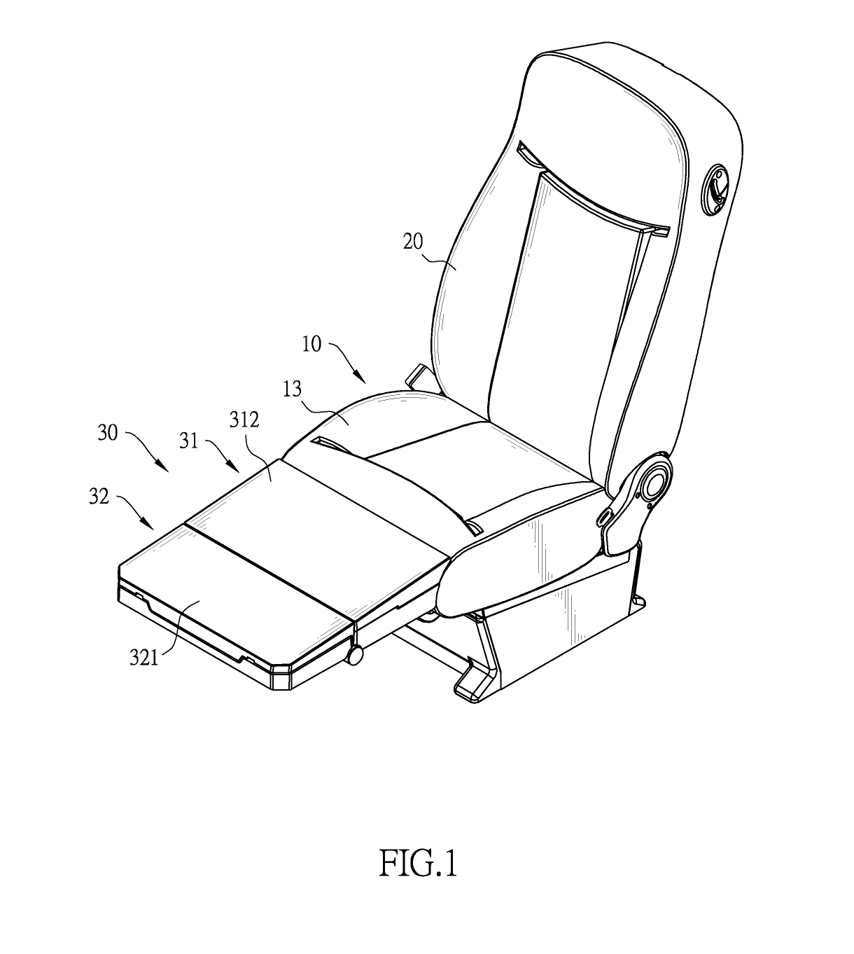

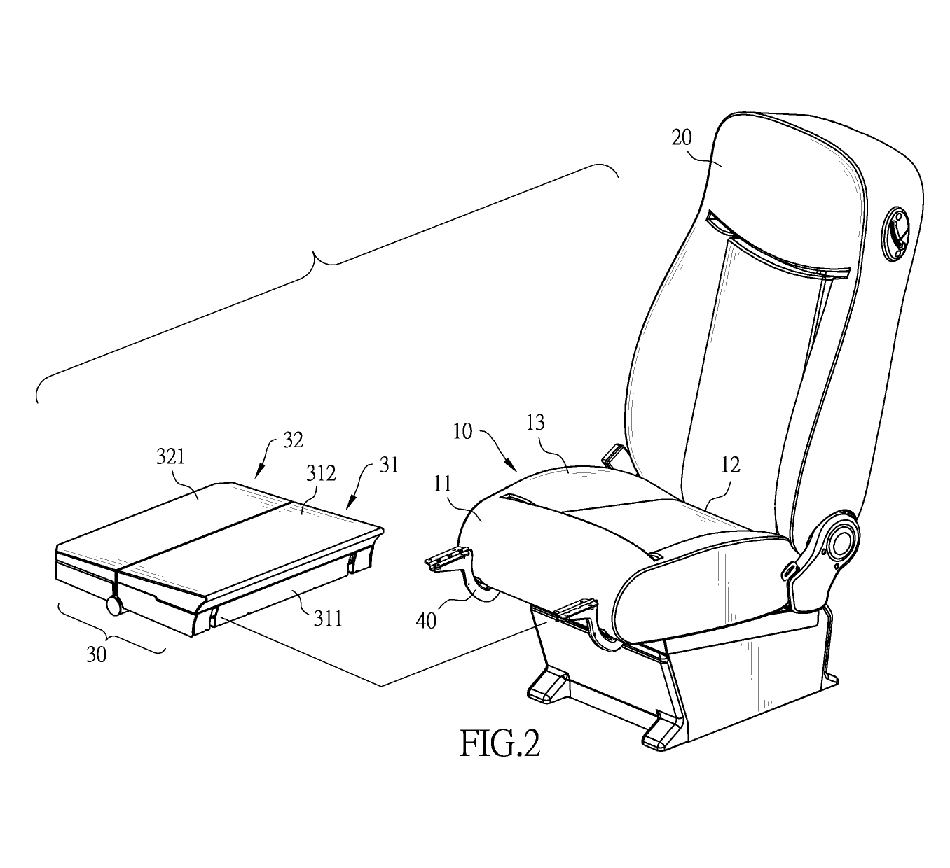

With reference to FIGS. 1 and 2, a seat with a flipping footrest assembly in accordance with the present invention comprises a cushion 10, a seat back 20, a footrest assembly 30 and at least one pivot arm 40.

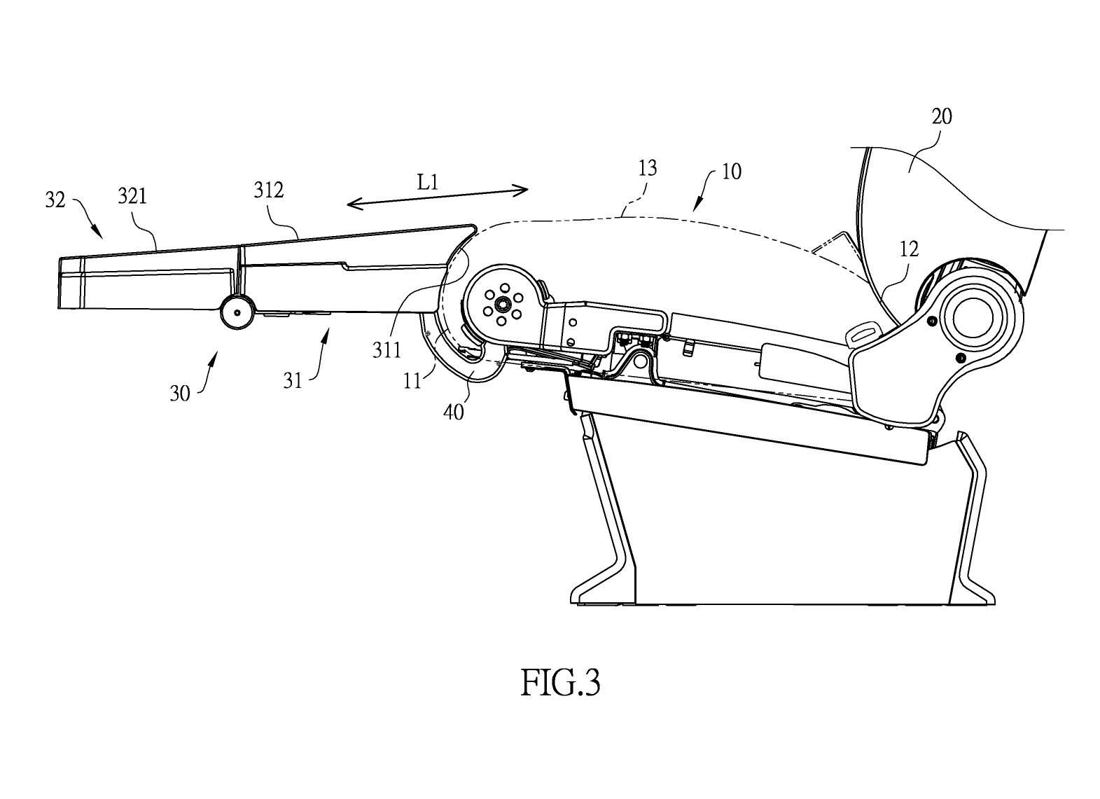

With reference to FIGS. 2 and 3, a front surface 11 of the cushion 10 is a convex surface. Specifically, from a side view, the convex surface is a front-protruding surface formed on the cushion 10.

The seat back 20 is mounted on a rear surface 12 of the cushion 10. The rear surface 12 of the cushion 10 is a surface disposed on an opposite side from the front surface 11 of the cushion 10. The seat back 20 extends upwardly from the cushion 10.

With reference to FIGS. 3, 4, and 5, the footrest assembly 30 is pivotally mounted on the front surface 11 of the cushion 10, and is capable of pivoting up and down relative to the cushion 10. The footrest assembly 30 comprises a first footrest 31 and a second footrest 32. The first footrest 31 is pivotally mounted on the front surface 11 of the cushion 10, and is capable of pivoting up and down relative to the cushion 10. A rear surface 311 of the first footrest 31 is adjacent to the front surface 11 of the cushion 10. The rear surface 311 of the first footrest 31 is a concave surface. Moreover, the rear surface 311 of the first footrest 31 corresponds in shape to the front surface 11 of the cushion 10. Specifically, when the first footrest 31 pivots up and down relative to the cushion 10, the rear surface 311 of the first footrest 31, which is concave, will move along the front surface 11 of the cushion 10, which is convex. Therefore, during the pivoting of the first footrest 31 and after the pivoting of the first footrest 31, there will be no excessive interspaces between the cushion 10 and the first footrest 31.

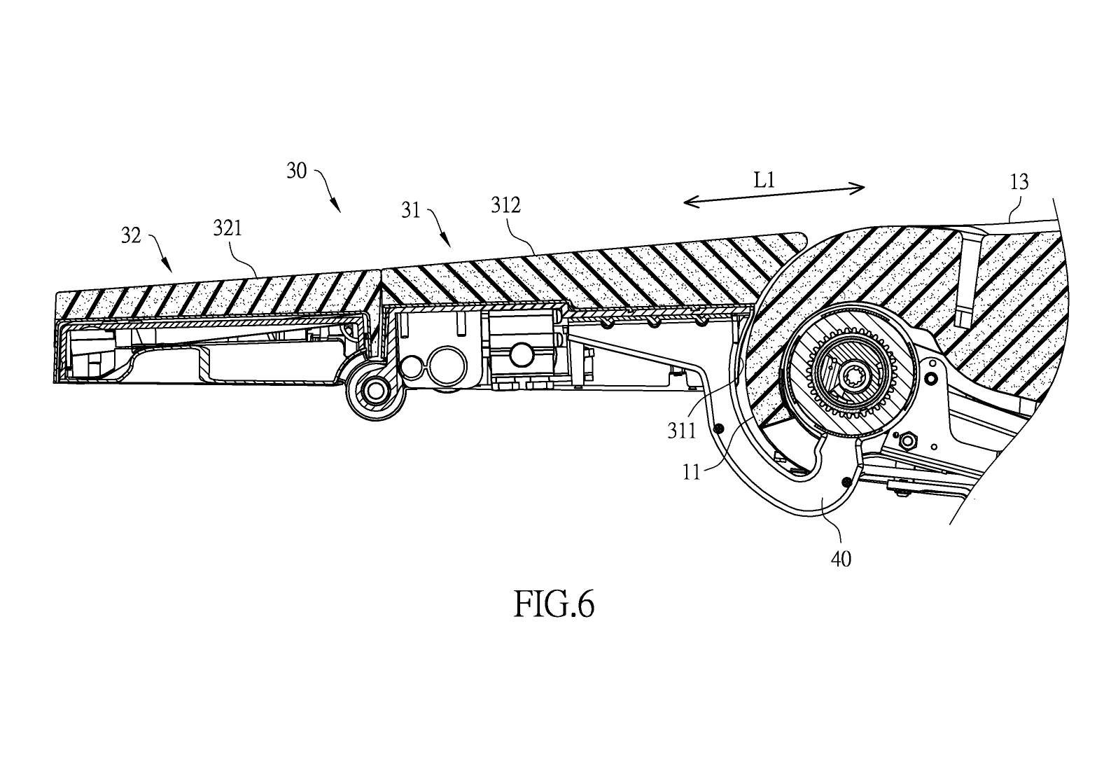

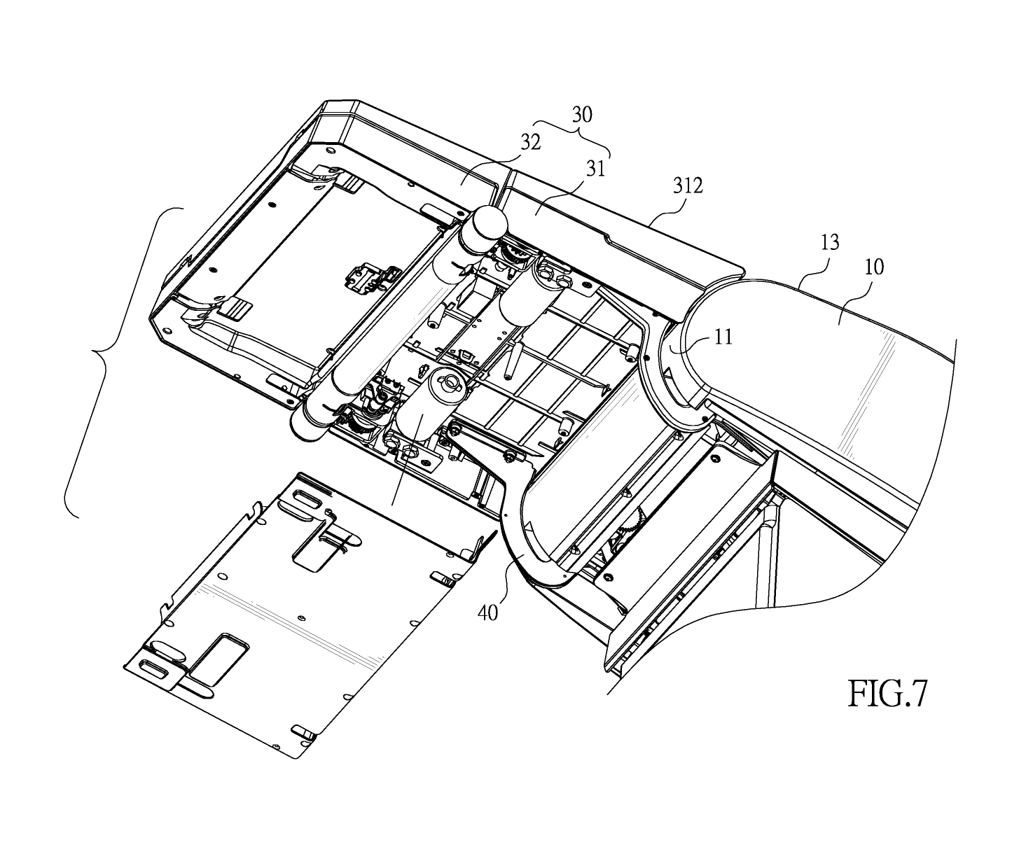

With reference to FIGS. 6 and 7, the second footrest 32 is pivotally mounted on the first footrest 31, and is capable of pivoting up and down relative to the first footrest 31.

With reference to FIGS. 2, 6, and 7, the at least one pivot arm 40 is pivotally mounted between the cushion 10 and the first footrest 31 of the footrest assembly 30. Specifically, in the present embodiment, a number of the at least one pivot arm 40 is two, each pivot arm 40 has an end pivotally mounted on a bottom surface of the cushion 10, and another end of said pivot arm 40 is mounted on a bottom surface of the first footrest 31. In other words, the first footrest 31 is pivotally connected with the cushion 10 through the two pivot arms 40. In the present embodiment, the two pivot arms 40 are connected to a left side and a right side of the bottom surface of the cushion 10 respectively.

The status of use is as follows.

With reference to FIGS. 3, 4, and 5, the footrest assembly 30 has a folded condition, a partially expanded condition, and an expanded condition.

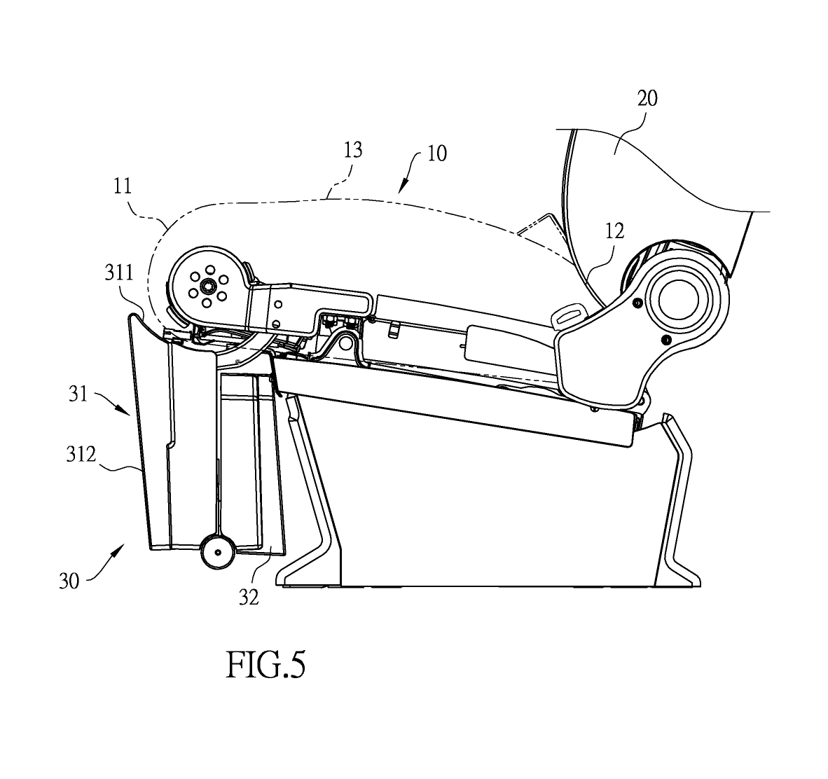

With reference to FIG. 5, in the folded condition, the first footrest 31 pivots relative to the cushion 10 to a position below the cushion 10, and the second footrest 32 pivots relative to the first footrest 31 to a rear end of the first footrest 31. In other words, in the folded condition, the whole footrest assembly 30 is disposed under the cushion 10.

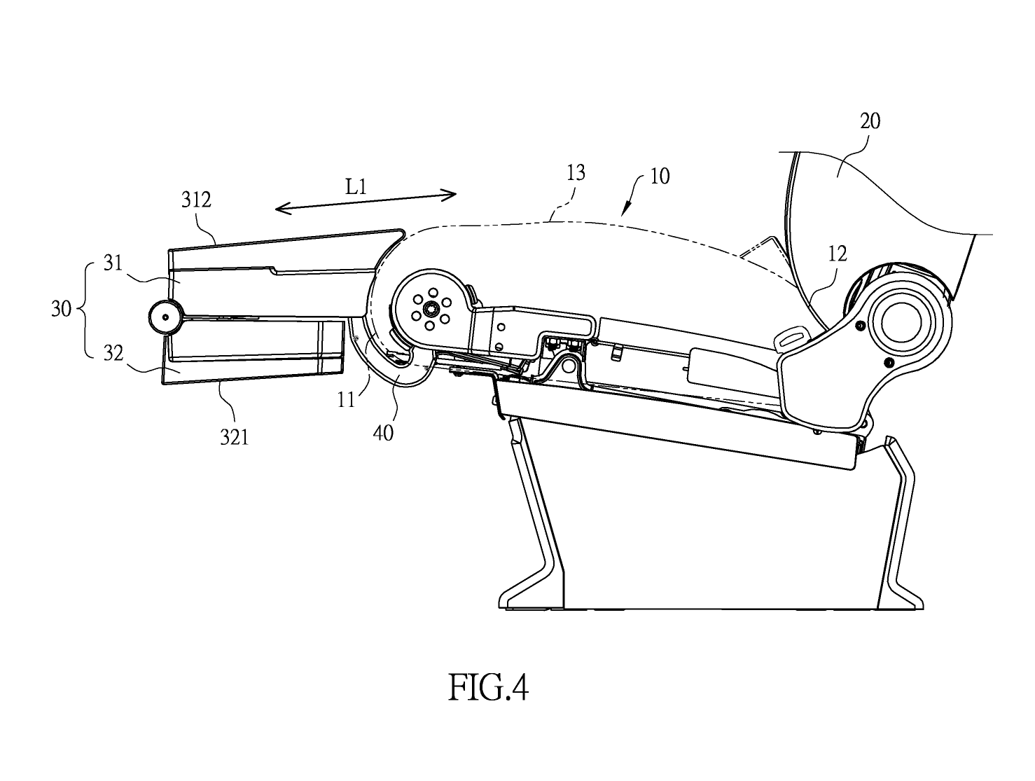

With reference to FIGS. 4 and 5, when the footrest assembly 30 is switched from the folded condition to the partially expanded condition, the first footrest 31 is pivoted relative to the cushion 10 and to a front end of the cushion 10. During the pivoting process, the rear surface 311 of the first footrest 31 is moved upwardly along the front surface 11 of the cushion 10.

With reference to FIGS. 4 and 6, furthermore, after the switch from the folded condition to the partially expanded condition, and from a side view, an extended surface of a top surface 312 of the first footrest 31 and a top surface 13 of the cushion 10 will jointly form a continuous and smooth line L1. In other words, when the first footrest 31 is flipped up relative to the cushion 10, a smooth and continuous surface is formed between the top surface 312 of the first footrest 31 and the top surface 13 of the cushion 10. An interspace is allowable on the smooth and continuous surface as long as the user's legs may be smoothly stretched and placed on said surface when the user is sitting on the cushion 10. That it, the smooth and continuous surface is not limited to a surface without any holes or gaps on it.

In the partially expanded condition, the first footrest 31 is pivoted relative to the cushion 10 to be nearly horizontal, but the pivot angle of the first footrest 31 is not limited thereto, as long as the user may fully stretch his/her legs on the first footrest 31. Besides, in this condition, because the pivoting of the first footrest 31, the second footrest 32 is relatively disposed under the first footrest 31.

With reference to FIGS. 3 and 4, when the footrest assembly 30 is switched from the partially expanded condition to the expanded condition, the second footrest 32 is pivoted relative to the first footrest 31 and to the front end of the first footrest 31. From the side view, the top surface 312 of the first footrest 31 and a top surface 321 of the second footrest 32 jointly form a smooth and continuous surface. In this condition, the second footrest 32, the first footrest 31 and the cushion 10 are sequentially disposed from front to rear.

When the present invention is in use, by switching the footrest assembly 30 sequentially from the folded condition to the partially expanded condition and the expanded condition, the user's legs may stretch out and be placed on the first footrest 31 and the second footrest 32. Furthermore, in the expanded condition, two smooth and continuous surfaces are respectively formed between the top surface 13 of the cushion 10 and the top surface 312 of the first footrest 31, and between the top surface 312 of the first footrest 31 and the top surface 321 of the second footrest 32. These two smooth and continuous surfaces have minimal or even no gaps and holes at all, therefore the user may comfortably stretch their legs on the footrest assembly 30.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A seat with a flipping footrest assembly comprising:
a cushion, a front surface of the cushion being a convex surface;
a seat back mounted on a rear surface of the cushion and extending upwardly; and
a footrest assembly pivotally mounted on the front surface of the cushion, being capable of pivoting up and down relative to the cushion, and comprising
a first footrest pivotally mounted on the front surface of the cushion and being capable of pivoting up and down relative to the cushion, a rear surface of the first footrest being adjacent to the front surface of the cushion and being a concave surface, the rear surface of the first footrest corresponding in shape to the front surface of the cushion, wherein when the first footrest pivots up and down relative to the cushion, the rear surface of the first footrest, which is concave, moves along the front surface of the cushion, which is convex; and
a second footrest pivotally mounted on the first footrest and being capable of pivoting up and down relative to the first footrest;
wherein the footrest assembly further comprises a folded condition, a partially expanded condition, and an expanded condition:
in the folded condition, the first footrest pivots relative to the cushion and pivots to a position below the cushion, the second footrest pivots relative to the first footrest and pivots to a rear end of the first footrest;
in the partially expanded condition, the first footrest pivots relative to the cushion and pivots to a front end of the cushion, the rear surface of the first footrest is disposed close to the front surface of the cushion, so from a side view, an extended surface of a top surface of the first footrest and a top surface of the cushion jointly form a continuous and smooth line, and the second footrest is disposed to a position below the first footrest;
in the expanded condition, the second footrest pivots relative to the first footrest and pivots to a front end of the first footrest, so the top surface of the first footrest and a top surface of the second footrest jointly form a continuous surface, and the second footrest, the first footrest and the cushion are disposed sequentially from front to rear.

2. The seat with a flipping footrest assembly as claimed in claim 1 further comprising at least one pivot arm, one end of the at least one pivot arm is pivotally mounted on a bottom surface of the cushion, another end of the at least one pivot arm is mounted on a bottom surface of the first footrest, the first footrest is capable of pivoting relative to the cushion through the pivoting of the at least one pivot arm.

3. The seat with a flipping footrest assembly as claimed in claim 2, wherein a number of the at least one pivot arm is two, and the two pivot arms are mounted on two sides of the bottom surface of the cushion respectively.
